(19) United States
(12) Patent Application Publication
(10) Pub. No.: US 2025/0045736 A1
(43) Pub. Date: Feb. 6, 2025

(54) END-USER CONTROLLED WALLETS IN BLOCKCHAIN SYSTEMS

(71) Applicant: CIRCLE INTERNET GROUP, INC., Boston, MA (US)

(72) Inventors: Ming Chang DONG, Tainan (TW); Huaiting HUANG, Taipei (TW); Ming Chang SHIH, Kaohsiung (TW); Zhiyu ZHANG, Needham, MA (US); Chi Huang FAN, Taipei (TW); Jordan FORSSMAN, Taipei (TW); Jayaprakash PAKALAPATI, Nashua, NH (US); Ka Wai TSUI, Boston, MA (US); Gagneet Singh MAC, Pacifica, CA (US); Yi-An LIN, Taipei (TW); Li TAO, Foster City, CA (US); Chiang HAN-ZHEN, Taipei (TW); Tzuyu HSU, Taipei (TW); Liu Chien WEI, Taipei (TW); Debra PENG, Taipei (TW); Nikhil KUMAR, Seattle, WA (US); Kok Peng LIM, Vancouver (CA); Andrew ZIMMER, Alberta (CA); Justin BELL, Sommerville, MA (US); Yingying ZHENG, Los Altos, CA (US)

(21) Appl. No.: 18/792,389

(22) Filed: Aug. 1, 2024

Related U.S. Application Data
(60) Provisional application No. 63/517,000, filed on Aug. 1, 2023.

(51) Int. Cl. G06Q 20/36; G06Q 20/38

(52) U.S. Cl. CPC G06Q 20/3674; G06Q 20/3825; G06Q 20/3829

(57) ABSTRACT

Certain aspects of the present disclosure provide techniques for securely accessing a wallet on a blockchain. An example method generally includes receiving a request to access a wallet on a blockchain. The request generally includes an authorization code associated with the wallet and user credentials associated with an owner of the wallet. A first portion of a private key is decrypted based on the authorization code and a salt associated with the user credentials, and a second portion of the private key is decrypted based on credentials associated with an application through which the wallet is accessed. Access to the wallet is granted based on the decrypted first portion and the decrypted second portion of the private key.

### CROSS-REFERENCE TO RELATED APPLICATIONS

This application claims benefit of and priority to U.S. Provisional Patent Application Ser. No. 63/517,000, entitled “End-User Controlled Wallets in Blockchain Systems,” filed Aug. 1, 2023, and assigned to the assignee hereof, the entire contents of which are hereby incorporated by reference.

### INTRODUCTION

Aspects of the present disclosure relate to security in blockchain systems, and more specifically to securing wallets in blockchain systems.

### BACKGROUND

Blockchains can be used in various decentralized systems to provide a ledger of transactions that have occurred within these decentralized systems. Generally, a blockchain may include a chain of blocks, in which latest block includes some information about a transaction that occurred and a reference to an immediate predecessor block, which may be a hashed value of the previous block. Because the reference to the immediate predecessor block may be a value derived from the immediate predecessor block, verification of the transactions in the blockchain may be performed by ensuring that a hash of a block resolves to the same value as that stored as a reference to the immediate predecessor block in a succeeding block in the blockchain. If there is a mismatch between a computed hash of a block and the hashed value of the block in a succeeding block in the blockchain, validation of the blockchain may fail.

To perform transactions on a blockchain system, wallets are generally established for users in order to hold and transfer assets on the blockchain. Generally, wallets on the blockchain are defined based on a private key and a corresponding public key. The public key allows for other users to transfer assets to the wallet. Meanwhile, the private key allows the owner of the wallet to access the contents of the wallet and initiate transactions on the blockchain (e.g., to transfer assets to another wallet, to withdraw assets from the wallet to another blockchain or an external source, etc.).

Because possession of a private key for a wallet allows for assets stored in the wallet to be withdrawn, preventing malicious actions from being taken in respect of a wallet generally involves maintaining secrecy around the private key. To do so, some applications link a private key to a series of words, or a recovery phrase, that a user can use to recover a private key associated with a wallet. These recovery phrases generally include a significant number of words. Because of the length of these recovery phrases, users often copy these phrases and store the copy of these phrases in insecure locations which can be easily accessed. In turn, because recovery phrases can often be easily accessed, the security of a wallet and the contents thereof may be compromised.

Accordingly, techniques are needed to allow for secure maintenance of wallets in blockchain systems.

### BRIEF SUMMARY

Certain embodiments provide a computer-implemented method for securely accessing a wallet on a blockchain. An example method generally includes receiving a request to access a wallet on a blockchain. The request generally includes an authorization code associated with the wallet and user credentials associated with an owner of the wallet. A first portion of a private key is decrypted based on the authorization code and a salt associated with the user credentials, and a second portion of the private key is decrypted based on credentials associated with an application through which the wallet is accessed. Access to the wallet is granted based on the decrypted first portion and the decrypted second portion of the private key.

Other embodiments provide processing systems configured to perform the aforementioned methods as well as those described herein; non-transitory, computer-readable media comprising instructions that, when executed by one or more processors of a processing system, cause the processing system to perform the aforementioned methods as well as those described herein; a computer program product embodied on a computer readable storage medium comprising code for performing the aforementioned methods as well as those further described herein; and a processing system comprising means for performing the aforementioned methods as well as those further described herein.

The following description and the related drawings set forth in detail certain illustrative features of one or more embodiments.

### BRIEF DESCRIPTION OF THE DRAWINGS

The appended figures depict certain aspects of the one or more embodiments and are therefore not to be considered limiting of the scope of this disclosure.

FIG. 1 depicts an example computing environment in which a private key defining a user wallet on a blockchain is secured using an authorization code, user credentials, and platform credentials, according to aspects of the present disclosure.

FIG. 2 is a message flow diagram illustrating messages exchanged between a key management system and a blockchain to establish a wallet based on an authorization code and user credentials, according to aspects of the present disclosure.

FIG. 3 is a message flow diagram illustrating messages exchanged between a key management system and a blockchain to perform transactions on the blockchain using assets in a wallet based on an authorization code and user credentials, according to aspects of the present disclosure.

FIG. 4 illustrates example operations for accessing a wallet on a blockchain based on an authorization code and user credentials, according to aspects of the present disclosure.

FIG. 5 illustrates an example system on which embodiments of the present disclosure can be performed.

To facilitate understanding, identical reference numerals have been used, where possible, to designate identical elements that are common to the drawings. It is contemplated that elements and features of one embodiment may be beneficially incorporated in other embodiments without further recitation.

### DETAILED DESCRIPTION

Transactions in cryptocurrency systems may be represented as blocks in a blockchain that track a universe of transactions performed using the cryptocurrency system. In these cryptocurrency systems, processed transactions may not be modified at a later date, thus providing an immutable ledger of the transactions performed using the cryptocurrency system.

Wallets, defined by a private key and public key pair, generally hold assets, such as native or non-native tokens, that can be transferred on a blockchain. In order to perform a transaction on a blockchain, a user generally signs a transaction using a private key associated with a wallet from which assets are being transferred on the blockchain. That is, a transaction generally identifies the assets to be transferred and the public address (or public key) of the transferee wallet to which these assets are transferred, and the transaction is signed using the private key associated with the transferor wallet. Decrypting the signature of the transaction, using the public key associated with the transferor wallet, allows for the transaction to be verified and thus for assets to be transferred from the transferor wallet to the transferee wallet upon verification of the transaction (e.g., by computing nodes participating in processing transactions on the blockchain).

Without access to a private key, thus, users are generally unable to perform transactions on a blockchain because users are unable to sign transactions for public verification by the computing nodes participating in processing transactions on the blockchain. Because access to a private key associated with a wallet grants access to the assets contained in a wallet and allows transactions to be performed with respect to the assets in the wallet, the privacy and security of the private key should be maintained. Various techniques are generally used to preserve access to the private key associated with a user's wallet. For example, users may maintain a record of the private key associated with their wallet in a separate (digital or physical) repository. In another example, because private key addresses are generally long alphanumeric strings which are difficult to remember, various key derivation techniques can be used to aid in the retrieval of the private key associated with the wallet. For example, a multi-word passphrase can be generated and used as an input into a key derivation function in order to generate (or retrieve) the private key associated with a wallet. However, while a passphrase may be less complicated to remember than the private key itself, the passphrase generally includes a sufficient number of words such that users store the passphrase in a separate (digital or physical) repository. Thus, users still maintain a record of the private key associated with their wallet in potentially insecure locations, thus exposing the private key of their wallets and potentially allowing malicious actors access to their wallets and the assets contained therein.

Aspects of the present disclosure provide techniques for improving the security of and ease of access to wallets used to conduct transactions on a blockchain by using an intermediate layer to access a private key defining a wallet and therefore introducing an abstraction layer to techniques for generating private keys defining the wallet. Generally, a private key can be sharded, or split, into multiple portions, with some portions being encrypted using user-provided credentials and other portions being encrypted using credentials associated with an application or platform on which the wallet is hosted. By doing so, multiple user-facing techniques can be exposed to allow a user to decrypt the portions of the private key encrypted using user-provided credentials, while not exposing techniques by which the private key itself can be directly recovered (e.g., by not exposing a passphrase or other private key recovery mechanism by which the entirety of the private key associated with a wallet can be recovered). By doing so, aspects of the present disclosure may allow users to easily access wallets while maintaining the security of these wallets, as a private key defining a wallet may not be derived directly from data known to a user of the application or platform hosting the wallet.

### Example Generation of and Access to End-User-Controlled Wallets in Blockchain Systems Using Sharded Private Keys

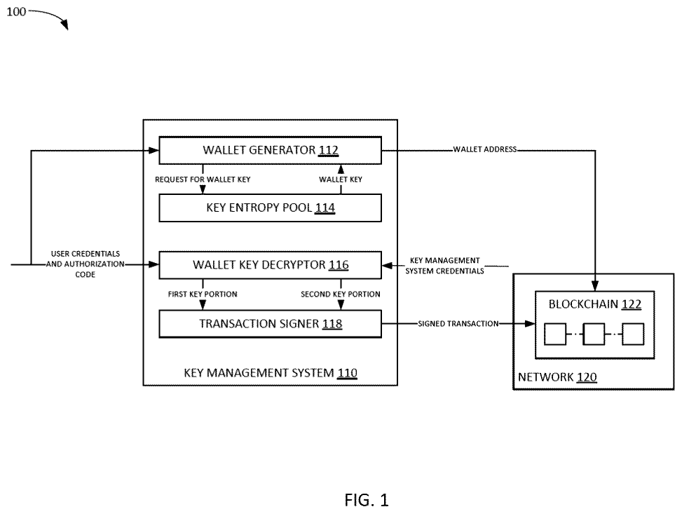

FIG. 1 illustrates an example computing environment 100 in which a private key defining a user wallet on a blockchain is secured using an authorization code, user credentials, and platform credentials. As illustrated, computing environment 100 includes a key management system 110 and a network 120.

Key management system 110 generally is representative of any system on which a private key defining a user wallet on a blockchain can be generated and accessed, such as a mobile device (e.g., smartphone, tablet, etc.), server computer hosting a service accessible by one or more remote systems, a cloud computing instance, or the like. As illustrated, key management system 110 includes a wallet generator 112, key entropy pool 114, wallet key decryptor 116, and a transaction signer 118.

As discussed, a wallet is generally defined in terms of a pairing of a public key and a private key. In order to perform a transaction on a blockchain, a user generally signs a transaction using a private key associated with a wallet from which assets are being transferred on the blockchain. That is, a transaction generally identifies the assets to be transferred and the public address (or public key) of the transferee wallet to which these assets are transferred, and the transaction is signed using the private key associated with the transferor wallet. Decrypting the signature of the transaction, using the public key associated with the transferor wallet, allows for the transaction to be verified and thus for assets to be transferred from the transferor wallet to the transferee wallet.

Wallet generator 112 generally receives requests to generate a wallet in which an owner of the wallet can store digital assets and initiate the transfer of digital assets to other users on blockchain 122. Generally, a request to generate a wallet may include an authorization code selected by the user for use in accessing the wallet at a future point in time and user credentials associated with a user's account on a platform provided by the key management system 110. The authorization code may include multiple alternatively usable mechanisms by which a user can be authenticated. Generally, these mechanisms may be information which the user knows, which the user is (e.g., data derived from user biometrics such as fingerprints, iris scans, facial characteristics, or the like), or other information which the user need not commit to a potentially insecure repository for retrieval when the user wishes to recover the private key defining a wallet. For example, the authorization code may include an alphanumeric personal identification number (PIN) code. As an alternative to or in addition to this alphanumeric PIN code, the authorization code may also include a series of questions and answers. The questions may be selected from an a priori defined list of questions or may be generated by the user requesting creation of a wallet through key management system 110.

Based on the received request to generate the wallet, wallet generator 112 requests and receives a private key and public key pairing from the key entropy pool 114. Generally, the key entropy pool 114 includes a plurality of private keys which can be assigned to users of key management system 110 who wish to establish a wallet for use in performing transactions on the blockchain 122, with each private key of the plurality of private keys having a corresponding public key. Keys included in the key entropy pool 114 generally are keys in which various elements of random data are stored and used as seeds to generate the private keys included in the key entropy pool (and the associated public keys). Because a key generator used to populate key entropy pool 114 uses random data that differs each time a key is generated, each key in the key entropy pool 114 may be unique and may not be derivable based on other keys in the key entropy pool 114.

To protect the private key selected from the key entropy pool 114, wallet generator 112 can split, or shard, the private key into multiple portions (or shards). These portions can be independently encrypted such that a compromise of the keys involved in encrypting one portion of the private key does not expose the entire private key, and thus the wallet associated with the private key, to a malicious party. For example, the private key can be sharded into a first portion and a second portion, with the first portion being encrypted based on the authorization code generated by a user that is creating a wallet using the key management system 110 and the second portion being encrypted based on credentials associated with an application through which the wallet is accessed. The first portion of the private key may be referred to herein as the “user portion” of the private key, and the second portion of the private key may be referred to herein as the “platform portion” of the private key.

In some aspects, multiple encrypted versions of the user portion of the private key may be generated to allow for the user portion to be recovered. For example, a first encrypted version of the user portion of the private key may be generated based, at least in part, on an alphanumeric authorization code and a second encrypted version of the user portion of the private key may be generated based on a series of question-answer pairs which the user can use as a “backup” mechanism for accessing the wallet associated with the private key. In such a case, a user can recover the user portion of the private key using the alphanumeric authorization code as a first option, and if the user does not remember the alphanumeric authorization code, can fall back to using the question-answer pairs to recover the user portion of the private key.

To generate the first encrypted version of the user portion of the private key, the alphanumeric authorization code can be augmented with a cryptographic salt, or random data which is appended to the alphanumeric authorization code in order to generate an encryption key used to protect the user portion of the private key. The cryptographic salt may be bound to a user credential associated with the user and may be further protected by a cryptographic key (or set of cryptographic keys) maintained by the key management system 110. By protecting this cryptographic salt using another set of cryptographic keys, the key management system 110 may ensure that malicious parties are unable to recover the cryptographic salt and thus are unable to recover the encryption key used to protect the user portion of the private key, as it is generally computationally impossible to execute a brute force attack against a sufficiently large search space. For example, assuming that the user portion of the private key is encrypted using a 128-bit key, a brute force attack generally involves 2¹²⁸=3.4*10³⁸ decryption attempts, which would take longer than the age of the universe to execute. The first encrypted version of the user portion of the private key may be generated using symmetric key cryptography, in which the same key is used to encrypt and decrypt a payload. In this example, the encryption/decryption key used to encrypt the first encrypted version of the user portion of the private key may be generated by concatenating the alphanumeric authorization code and the cryptographic salt into a string representing the encryption/decryption key.

To generate the second encrypted version of the user portion of the private key, the series of question-answer pairs generated by the user may be converted into an encryption/decryption key using various key derivation functions. The derived key may then be used to encrypt the user portion of the private key, which may be stored at key management system 110, and decrypt the user portion of the private key upon request by the user.

In some aspects, to protect the platform portion of the private key, the platform portion of the private key may be further sharded into different sub-portions. Each of these sub-portions may be independently encrypted using different keys so that a compromise of one set of cryptographic keys maintained by the key management system 110, or a platform outage by a portion of the key management system 110, does not compromise the wallet private key in its entirety. In this example, key management system 110 may be maintained across different systems (e.g., different cloud compute instances), with each system being associated with a unique cryptographic key. In a scenario in which a system associated with a specific cryptographic key fails, a failover process can allow the system to be recovered on a different physical or cloud compute instance so that recovery of private keys, and thus access to the associated wallets, through the key management system 110 is not significantly interrupted.

In some aspects, to further protect wallet private keys from attacks, such as a man-in-the-middle attack in which a malicious user interposes itself as the key management system 110, the key management system 110 can further encrypt the private key associated with a wallet, prior to sharding and individual encryption, using a platform-specific set of keys. In this example, decrypting the first portion of the private key using the authorization code associated with the wallet and the second portion of the private key using the credentials associated with the key management system 110, and concatenating these decrypted portions of the private key, may recover an intermediate encrypted version of the private key instead of the private key itself. Because the resulting version of the private key is not the actual private key, but instead an intermediate encrypted version of the private key, a man-in-the-middle attack mail fail to identify the actual private key associated with the wallet. Further, because brute force attacks of a cryptographic scheme (given a sufficient key size) are computationally impossible to execute (as discussed above), the recovery of the intermediate encryption version of the private key may still not allow for a malicious user to access a wallet.

The wallet generated by wallet generator 112 may be made publicly known on blockchain 122 to allow for other parties to transfer assets into the wallet. Generally, in making the wallet publicly known, the public key associated with the wallet may be published to other parties on the network 120. As discussed, knowledge of the public key associated with the wallet may allow other users to specify the wallet as the destination address for assets to be transferred in one or more transactions on the blockchain 122. However, knowledge of the public key generally does not allow for assets to be withdrawn or transferred from the wallet.

To execute transactions on the blockchain, key management system 110 allows a user to request the private key associated with the wallet through wallet key decryptor 116. Generally, wallet key decryptor 116 receives, from the user, user credentials and an authorization code associated with the user and uses these credentials to decrypt encrypted versions of the user portion of the private key. Meanwhile, the wallet key decryptor 116 also receives or retrieves platform-specific credentials for use in decrypting encrypted versions of the platform portion of the private key. To decrypt the user portion of the private key, wallet key decryptor 116 can use the user credentials to decrypt a cryptographic salt associated with the user and concatenate the decrypted version of the cryptographic salt with an alphanumeric authorization code associated with the user to generate a decryption key. Wallet key decryptor 116 subsequently uses the decryption key to recover the user portion of the private key.

In some aspects, where the user has forgotten the alphanumeric authorization code, alternative authorization codes can be used to recover the user portion of the private key. For example, as discussed, a decryption key may be generated by a key derivation function, using a series of question-answer pairs as an input. If wallet key decryptor 116 verifies that the user has answered the question-answer pairs correctly, wallet key decryptor 116 can input the question-answer pairs into the key derivation function to recover a decryption key. Wallet key decryptor 116 subsequently uses the decryption key to recover the user portion of the private key.

As discussed, wallet key decryptor 116 can use the platform-specific credentials to decrypt the platform portion of the private key associated with the requested wallet. These platform-specific credentials may include, for example, a cryptographic key used in a symmetric encryption algorithm or a private key used to decrypt a payload encrypted using a corresponding public key. In some aspects, multiple platform-specific credentials may be used to encrypt (and thus to decrypt) different sub-portions of the platform portion of the private key. In such an example, individual sub-portions of the platform portion of the private key may be independently decrypted (e.g., by wallet key decryptor 116 at key management system 110 or on a remote system, not illustrated in FIG. 1). The decrypted sub-portions of the platform portion of the private key may then be concatenated into the whole platform portion of the private key for use in recovering the private key associated with the wallet and granting access to the wallet, as discussed in further detail below.

In some aspects, as illustrated, wallet key decryptor 116 may output the decrypted first key portion and the decrypted second key portion to transaction signer 118 for use in signing a transaction to be committed to the blockchain 122. Transaction signer 118 can generate the private key, which grants the user access to the wallet associated with the private key, by concatenating the decrypted first key portion and the decrypted second key portion into a single key. This decrypted key may then be used to sign a transaction record, which generally includes information defining assets transferred on the blockchain 122 as part of the transaction and the public key of the destination wallet to which the assets are to be transferred. Transaction signer 118 may then output the signed transaction to blockchain 122 for publication, verification, and finalization.

In some aspects, as discussed, the user portion and the platform portion of the wallet private key may be further protected by a set of keys associated with the key management system 110. To recover the wallet private key and grant access to the wallet, the user portion and the platform portion of the wallet private key may be combined (e.g., concatenated), and the combination of the user portion and the platform portion of the wallet private key may be decrypted using the set of keys associated with the key management system 110. As discussed, further encrypting the user portion and the platform portion of the wallet private key may provide further protection against malicious attacks, such as a man-in-the-middle attack, as such additional encryption of the wallet private key may require that malicious parties have possession of additional information beyond a user's authorization code and other credentials in order to compromise a specific wallet, and because a brute force attack to recover any specific wallet private key is computationally impossible to perform.

Network 120 may, in some aspects, be a cryptocurrency network for which key management system 110 processes transactions. By way of example, network 120 may be a network such as ALGORAND™, BITCOIN™, ETHEREUM®, SOLANA™, STELLAR™, TRON™, and other cryptocurrency networks. Transactions on a blockchain 122 hosted by network 120 may include, for example, the execution of one or more smart contracts on the blockchain 122 or by the generation of one or more blocks on the blockchain evidencing the occurrence of a transaction on the blockchain 122.

### Example End-User-Controlled Wallet Private Key Generation and Access

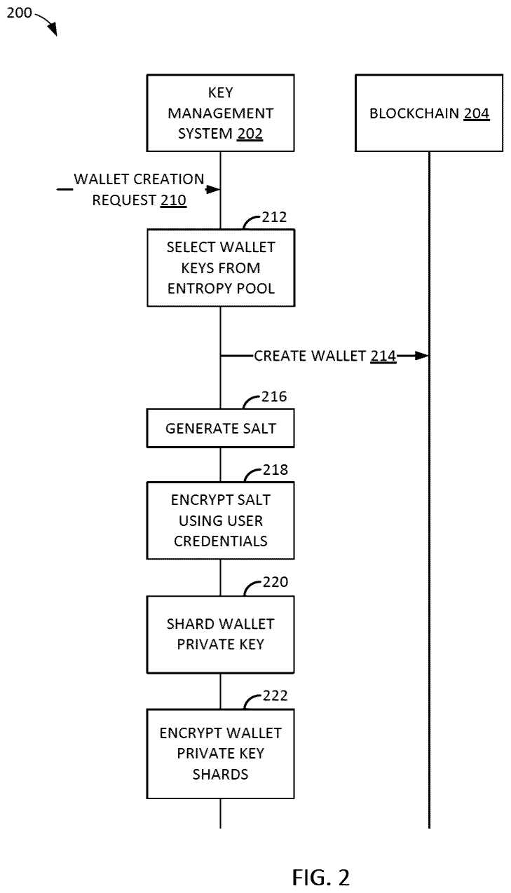

FIG. 2 illustrates operations 200 that may be performed by a key management system 202 and a blockchain 204 to establish a wallet based on an authorization code and user credentials, according to aspects of the present disclosure. The key management system 202 may correspond, for example, to key management system 110 illustrated in FIG. 1, and the blockchain 204 may correspond to the blockchain 122 illustrated in FIG. 1.

As illustrated, a wallet generation process is generally prompted by the receipt, at key management system 202, of a wallet creation request 210 from a user of the key management system 202. The wallet creation request 210 generally includes an authorization code associated with the owner of the wallet and user credentials associated with the owner of the wallet. As discussed, the authorization code may include multiple authentication mechanisms, such as an alphanumeric code, a series of question-answer pairs, or the like. Generally, the authorization code may be data that the user of the key management system 202 knows, is, or has possession of.

Response to receipt of the wallet creation request 210, the key management system 202 selects wallet keys from an entropy pool at block 212. The wallet keys may include a public key which may be published to allow other parties on the blockchain 204 to specify the wallet as a destination wallet for digital assets to be transferred on the blockchain 204 via one or more signed transactions and a private key which allows the owner of the wallet to access the digital assets contained in the wallet. In some aspects, the wallet keys may be generated using a random generator that uses data in the entropy pool, such as log data or other random data that cannot be easily replicated, in order to generate a set of keys from which subsequently generated keys cannot be derived and which cannot itself be derived from previously generated keys. After the keys are selected from the entropy pool at block 212, a wallet creation message 214 is published on the blockchain to establish the wallet as a location into which digital assets can be received and a location from which digital assets can be transmitted.

To protect the private key, key management system 202 proceeds to generate a salt at block 216. The salt may be a randomly generated alphanumeric string, a randomly generated number, or some other data which cannot easily be recovered or replicated and which can be used to augment an authentication code received from the user of the key management system 202. At block 218, the key management system 202 proceeds to encrypt the salt using the user credentials received in wallet creation request 210. The encrypted salt may be stored with the user credentials in an access management system used by key management system 202 to authenticate a user and grant the user access to the key management system 202.

At block 220, the wallet private key is sharded into a plurality of portions, or shards. Each shard may correspond to a unique portion of the wallet private key and may be encrypted separately using one or more encryption techniques and sets of keys.

At block 222, the key management system 202 encrypts the wallet private key shards. As discussed, the wallet private key shards may correspond to a user portion of the wallet private key and a platform portion of the wallet private key. To protect the user portion of the wallet private key and allow for the user portion to be recovered, multiple encrypted versions of the user portion of the wallet private key may be generated. A first encrypted version of the user portion of the wallet private key may be encrypted using a cryptographic key generated based on a concatenation or other combination of an alphanumeric authorization code and the cryptographic salt generated at block 216. Meanwhile, a second encrypted version of the user portion of the wallet private key may be encrypted using a cryptographic key generated based on a key derivation function using a series of question-answer pairs as an input. It should be recognized, however, that other data sources can be used to generate the second encrypted version of the user portion of the wallet private key, and the foregoing provides non-limiting examples of the data based on which encryption keys used to encrypt the user portion of the wallet private key can be generated.

Meanwhile, the key management system 202 uses various platform-specific credentials to encrypt the platform portion of the wallet private key. In some aspects, to protect against security risks that may exist from using a single system to encrypt the platform portion of the wallet private key, multiple encrypted versions of the wallet private key can be generated. In one example, the platform portion of the wallet private key may be encrypted using multiple key pairs, and the platform portion of the wallet private key may be verified by ensuring that the different decrypted versions of the platform portion of the wallet private key match. In another example, the platform portion of the wallet private key may be divided into a plurality of sub-portions, with each sub-portion being independently protected using different sets of encryption/decryption keys (which, in some aspects, may correspond to keys for different authentication systems used within a computing environment). The encrypted platform portion of the wallet private key may be stored with user credentials to allow for future access to the wallet through key management system 202.

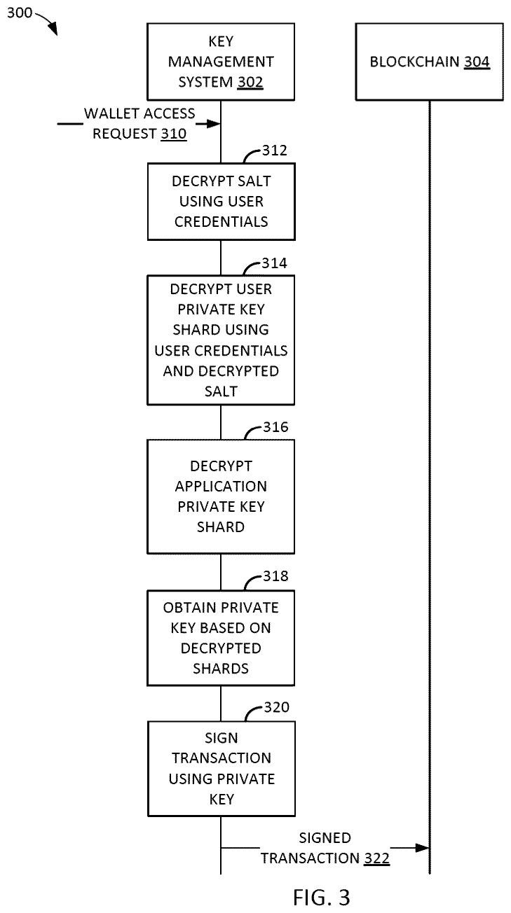

FIG. 3 illustrates example operations 300 that may be performed by a key management system 302 and a blockchain 304 to perform transactions on the blockchain 304 using assets in a wallet based on an authorization code and user credentials, according to aspects of the present disclosure. The key management system 302 may correspond, for example, to key management system 110 illustrated in FIG. 1, and the blockchain 304 may correspond to the blockchain 122 illustrated in FIG. 1.

As illustrated, to execute a transaction on the blockchain 304, a wallet access request 310 may be received at key management system 302. The wallet access request generally includes user credentials, a user authentication code, information identifying digital assets to be transferred as part of a transaction, and the public key of the wallet to which the identified digital assets are to be transferred.

At block 312, key management system 302 decrypts a cryptographic salt using user credentials included in the wallet access request 310. For example, the user credentials may be associated with a decryption key (which may be a key in a symmetric or an asymmetric encryption scheme) used to encrypt the cryptographic salt. The decryption key may be used to decrypt an encrypted payload (e.g., from user profile or user account data stored at key management system 302 or another user identity authority) and recover the cryptographic salt from the encrypted payload.

At block 314, key management system 302 decrypts the user private key shard (e.g., the user portion of the private key) using user credentials and the decrypted cryptographic salt. In some aspects, the user credentials may be an alphanumeric PIN code that may be combined with the cryptographic salt to generate the user private key shard. In some aspects, where the user has entered a recovery model, the user credentials may be other data which the user can input into a key derivation function in order to recover the private key shard, alone or in combination with the decrypted cryptographic salt.

At block 316, key management system 302 decrypts the application private key shard (e.g., the platform portion of the private key, as discussed above). The application private key shard may be decrypted from an encrypted payload stored as part of a user profile (e.g., stored at key management system 302 or another user identity authority) using decryption keys associated with the key management system 302 and/or other systems involved in authenticating users of key management system 302, processing transactions to be committed to blockchain 304, and the like. In some aspects, the application private key shard may be divided into multiple sub-portions, with different decryption keys being used to decrypt different portions of the application private key shard.

At block 318, key management system 302 obtains the wallet private key based on the decrypted user private key shard and the decrypted application private key shard. In some aspects, the wallet private key may be generated by concatenating the decrypted user private key shard and the decrypted application private key shard into a single key, represented by a string of a defined bit length corresponding to the encryption bit length used by a cryptographic scheme used to sign transactions on blockchain 304.

At block 320, key management system 302 signs a transaction using the wallet private key. The transaction generally includes information identifying the digital assets to be transferred as part of the transaction and a destination wallet for the identified digital assets. The signed transaction 322 is then output from key management system 302 to the blockchain 304 for processing.

### Example Operations for Accessing Wallets in Blockchain Systems Using Sharded Private Keys

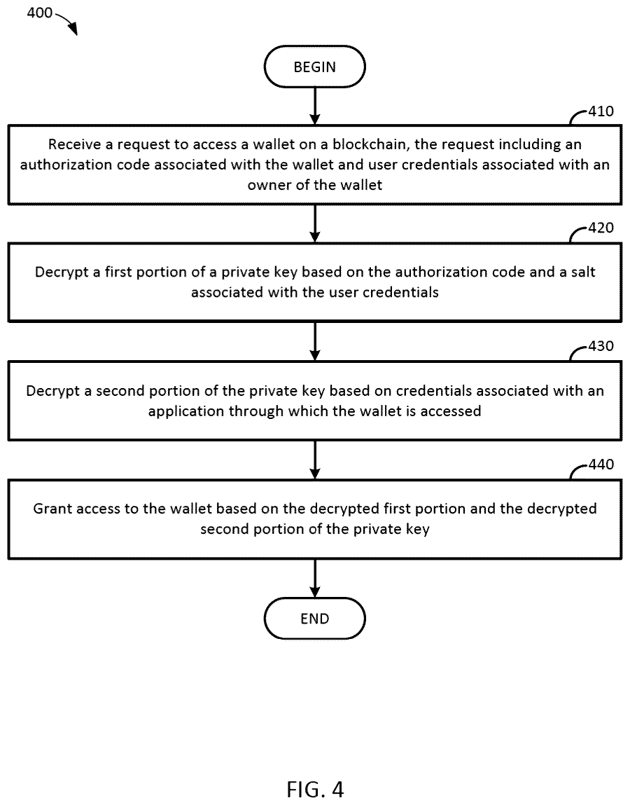

FIG. 4 illustrates example operations 400 for accessing a wallet on a blockchain based on an authorization code and user credentials, according to aspects of the present disclosure. Operations 400 may be performed, for example, by a key management system 110 illustrated in FIG. 1 or other processing system that can grant access to a wallet used in performing transactions on a blockchain.

As illustrated, operations 400 begin at block 410, with receiving a request to access a wallet on a blockchain. Generally, the request includes an authorization code associated with the wallet and user credentials associated with an owner of the wallet.

In some aspects, the authorization code associated with the wallet includes an alphanumeric string generated by the owner of the wallet.

In some aspects, the authorization code associated with the wallet includes one or more question-answer pairs. The questions may be selected from a set of a priori defined questions, and the answers may be generated by the owner of the wallet. As discussed, the one or more question-answer pairs may be used as a recovery mechanism to allow a user to recover a private key associated with the wallet, or at least a user portion of the private key, in the event that the user has forgotten a primary authorization code associated with the private key.

At block 420, operations 400 proceed with decrypting a first portion of a private key based on the authorization code and a salt associated with the user credentials. In some aspects, the salt may be a randomly generated number encrypted using a key associated with the user credentials. The key associated with the user credentials may be, for example, stored as part of a user profile at a key management system or other user identity authority, or may be derived from the user credentials using a key derivation function.

At block 430, operations 400 proceed with decrypting a second portion of the private key based on credentials associated with an application through which the wallet is accessed.

In some aspects, the second portion of the private key may include at least a first sub-portion and a second sub-portion. To decrypt the second portion of the private key, the first sub-portion may be decrypted based on a first set of credentials associated with the application, and the second sub-portion may be decrypted based on a second set of credentials associated with the application.

At block 440, operations 400 proceed with granting access to the wallet based on the decrypted first portion and the decrypted second portion of the private key.

In some aspects, granting access to the wallet may include granting access to withdraw items stored in the wallet to an external resource based on signing a transaction using the decrypted first portion and the decrypted second portion of the private key.

In some aspects, granting access to the wallet includes generating an intermediate encrypted version of the private key based on the decrypted first portion and the decrypted second portion of the private key. The private key may be decrypted based on the intermediate encrypted version of the private key and a platform-specific decryption key, and the decrypted private key may grant access to the wallet.

In some aspects, operations 400 further include receiving a request to generate the wallet, the request including at least the authorization code associated with the wallet. A private key associated with the wallet may be selected from an entropy pool of private keys, the wallet may be generated based on the selected private key.

### Example System for Generating and Granting Access to Wallets in Blockchain Systems Using Sharded Private Keys

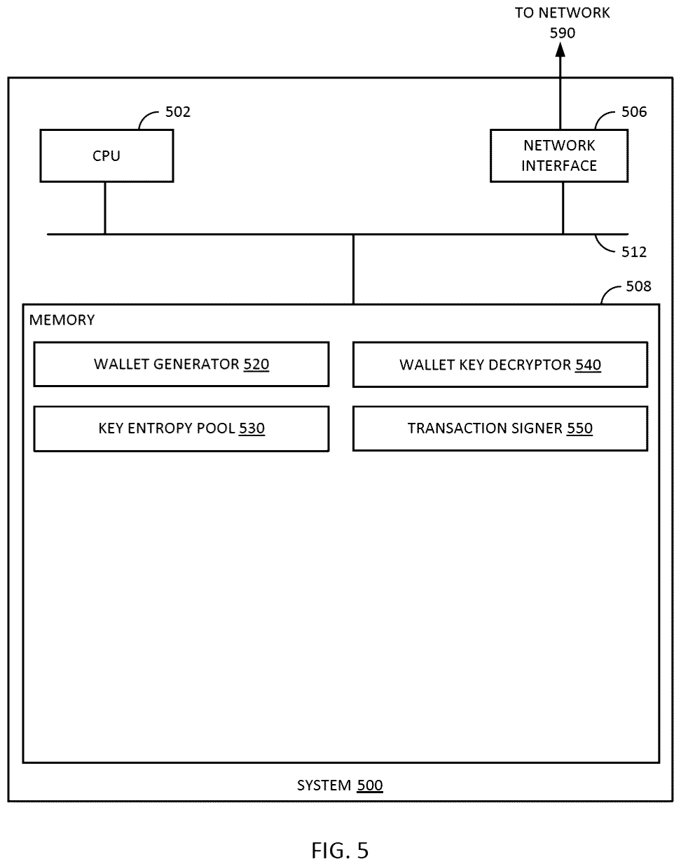

FIG. 5 illustrates an example system 500 configured to perform the methods described herein, including, for example, operations 200 illustrated in FIG. 2, operations 300 illustrated in FIG. 3, and/or operations 400 illustrated in FIG. 4. In some embodiments, system 500 may act as a key management system through which wallets are maintained, such as key management system 110 illustrated in FIG. 1.

As shown, system 500 includes a central processing unit (CPU) 502, network interface 506 through which system 500 is connected to network 590 (which may be a local network, an intranet, the internet, or any other group of computing devices communicatively connected to each other), a memory 508, and an interconnect 512. The network interface 506 may be used to receive requests to upgrade bridged tokens on a blockchain to native tokens on the blockchain (e.g., as depicted and described with respect to FIGS. 1 through 4.

CPU 502 may retrieve and execute programming instructions stored in the memory 508. Similarly, the CPU 502 may retrieve and store application data residing in the memory 508. The interconnect 512 transmits programming instructions and application data, among the CPU 502, network interface 506, and memory 508.

CPU 502 is included to be representative of a single CPU, multiple CPUs, a single CPU having multiple processing cores, and the like.

Memory 508 is representative of a volatile memory, such as a random access memory, or a nonvolatile memory, such as nonvolatile random access memory, phase change random access memory, or the like. As shown, memory 508 includes a wallet generator 520, a key entropy pool 530, a wallet key decryptor 540, and a transaction signer 550.

Wallet generator 520 generally corresponds to wallet generator 112 illustrated in FIG. 1. Generally, wallet generator 520 receives a request to generate a wallet for a user. To generate a wallet, wallet generator retrieves a public key and private key pair from key entropy pool 530 (which may correspond to key entropy pool 114 illustrated in FIG. 1). The private key may be sharded into a user portion and a platform portion, with the user portion being encrypted using an authentication code and user credentials included in the received request and the platform portion being encrypted using credentials associated with the system 500. In some aspects, the user portion may be encrypted using multiple techniques. A first encrypted version of the user portion may be encrypted based on a combination of a user-provided authentication code and a cryptographic salt, which may be encrypted using the user credentials; meanwhile, a second encrypted version of the user portion may be encrypted based on a key derived from a set of question-answer pairs established by the user of system 500.

Key entropy pool 530 generally includes a plurality of private keys generated using random seeds or other random data input into a random key address generator. A key selected from the key entropy pool 530 may not be derived from keys previously generated by or within key entropy pool 530, and subsequent keys in the key entropy pool 530 may not be derived from the selected key.

Wallet key decryptor 540 generally corresponds to wallet key decryptor 116 illustrated in FIG. 1. Generally, wallet key decryptor 540 receives a request to access a wallet from a user of system 500. The request generally includes an authorization code and user credentials associated with the owner of the wallet. To grant access to the wallet, wallet key decryptor 540 decrypts the user portion of the wallet private key based on the authorization code and user credentials included in the request and decrypts the platform portion of the wallet private key based on platform credentials associated with system 500 (and/or other authentication or user identity authorities which may be used to authenticate a user and protect the secrecy of wallet private keys).

Transaction signer 550 generally corresponds to transaction signer 118 illustrated in FIG. 1. Generally, transaction signer 550 uses the decrypted user portion and the decrypted platform portion of the wallet private key to recover the wallet private key and grant the user access to the wallet. Generally, the decrypted user portion of the private key may be combined with the decrypted platform portion of the private key in order to recover the wallet private key. The recovered private key may then be used to grant access to digital assets stored in the wallet associated with the wallet private key, sign transaction records evidencing the transfer of digital assets from the wallet associated with the wallet private key to a recipient wallet, and the like. These transaction records may then be output (e.g., via network interface 506) to a blockchain (e.g., on network 590) for further processing.

### Example Clauses

Implementation details for various aspects of the present disclosure are described in the following numbered clauses.

Clause 1: A computer-implemented method, comprising: receiving a request to access a wallet on a blockchain, the request including an authorization code associated with the wallet and user credentials associated with an owner of the wallet; decrypting a first portion of a private key based on the authorization code and a salt associated with the user credentials; decrypting a second portion of the private key based on credentials associated with an application through which the wallet is accessed; and granting access to the wallet based on the decrypted first portion and the decrypted second portion of the private key.

Clause 2: The method of Clause 1, wherein the authorization code associated with the wallet comprises an alphanumeric string.

Clause 3: The method of any of Clauses 1 or 2, wherein the authorization code associated with the wallet comprises one or more question-answer pairs.

Clause 4: The method of any of Clauses 1 through 3, wherein decrypting the second portion of the private key comprises decrypting a first sub-portion of the second portion based a first set of credentials associated with the application and a second sub-portion of the second portion based on a second set of credentials associated with the application.

Clause 5: The method of any of Clauses 1 through 4, wherein the salt comprises a randomly generated number encrypted using a key associated with the user credentials.

Clause 6: The method of any of Clauses 1 through 5, further comprising: receiving a request to generate the wallet, the request including at least the authorization code associated with the wallet; selecting the private key associated with the wallet from an entropy pool of private keys; and generating the wallet based on the selected private key.

Clause 7: The method of any of Clauses 1 through 6, wherein granting access to the wallet comprises granting access to withdraw items stored in the wallet to an external resource based on signing a transaction using the decrypted first portion and the decrypted second portion of the private key.

Clause 8: The method of any of Clauses 1 through 7, wherein granting access to the wallet comprises: generating an intermediate encrypted version of the private key based on the decrypted first portion and the decrypted second portion of the private key; and decrypting the private key based on the intermediate encrypted version of the private key and a platform-specific decryption key, wherein the decrypted private key grants access to the wallet.

Clause 9: A system, comprising: a memory having executable instructions stored thereon; and a processor configured to execute the executable instructions to perform the operations of any one of Clauses 1 through 8.

Clause 10: A system, comprising: means for performing the operations of any one of Clauses 1 through 8.

Clause 11: A computer-readable medium having instructions stored thereon which, when executed by a processor, performs the operations of any one of Clauses 1 through 8.

### Additional Considerations

The preceding description is provided to enable any person skilled in the art to practice the various embodiments described herein. Various modifications to these embodiments will be readily apparent to those skilled in the art, and the generic principles defined herein may be applied to other embodiments. For example, changes may be made in the function and arrangement of elements discussed without departing from the scope of the disclosure. Various examples may omit, substitute, or add various procedures or components as appropriate. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The various illustrative logical blocks, modules and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

A processing system may be implemented with a bus architecture. The bus may include any number of interconnecting buses and bridges depending on the specific application of the processing system and the overall design constraints. The bus may link together various circuits including a processor, machine-readable media, and input/output devices, among others. A user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further. The processor may be implemented with one or more general-purpose and/or special-purpose processors. Examples include microprocessors, microcontrollers, DSP processors, and other circuitry that can execute software. Those skilled in the art will recognize how best to implement the described functionality for the processing system depending on the particular application and the overall design constraints imposed on the overall system.

If implemented in software, the functions may be stored or transmitted over as one or more instructions or code on a computer-readable medium. Software shall be construed broadly to mean instructions, data, or any combination thereof, whether referred to as software, firmware, middleware, microcode, hardware description language, or otherwise. Computer-readable media include both computer storage media and communication media, such as any medium that facilitates transfer of a computer program from one place to another. The processor may be responsible for managing the bus and general processing, including the execution of software modules stored on the computer-readable storage media. A computer-readable storage medium may be coupled to a processor such that the processor can read information from, and write information to, the storage medium. In the alternative, the storage medium may be integral to the processor. By way of example, the computer-readable media may include a transmission line, a carrier wave modulated by data, and/or a computer readable storage medium with instructions stored thereon separate from the wireless node, all of which may be accessed by the processor through the bus interface. Alternatively, or in addition, the computer-readable media, or any portion thereof, may be integrated into the processor, such as the case may be with cache and/or general register files. Examples of machine-readable storage media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product.

A software module may comprise a single instruction, or many instructions, and may be distributed over several different code segments, among different programs, and across multiple storage media. The computer-readable media may comprise a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module, it will be understood that such functionality is implemented by the processor when executing instructions from that software module.

The following claims are not intended to be limited to the embodiments shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A computer-implemented method, comprising:
receiving a request to access a wallet on a blockchain, the request including an authorization code associated with the wallet and user credentials associated with an owner of the wallet;
decrypting a first portion of a private key based on the authorization code and a salt associated with the user credentials;
decrypting a second portion of the private key based on credentials associated with an application through which the wallet is accessed; and
granting access to the wallet based on the decrypted first portion and the decrypted second portion of the private key.

2. The method of claim 1, wherein the authorization code associated with the wallet comprises an alphanumeric string.

3. The method of claim 1, wherein the authorization code associated with the wallet comprises one or more question-answer pairs.

4. The method of claim 1, wherein decrypting the second portion of the private key comprises decrypting a first sub-portion of the second portion based a first set of credentials associated with the application and a second sub-portion of the second portion based on a second set of credentials associated with the application.

5. The method of claim 1, wherein the salt comprises a randomly generated number encrypted using a key associated with the user credentials.

6. The method of claim 1, further comprising:
receiving a request to generate the wallet, the request including at least the authorization code associated with the wallet;
selecting the private key associated with the wallet from an entropy pool of private keys; and
generating the wallet based on the selected private key.

7. The method of claim 1, wherein granting access to the wallet comprises granting access to withdraw items stored in the wallet to an external resource based on signing a transaction using the decrypted first portion and the decrypted second portion of the private key.

8. The method of claim 1, wherein granting access to the wallet comprises:
generating an intermediate encrypted version of the private key based on the decrypted first portion and the decrypted second portion of the private key; and
decrypting the private key based on the intermediate encrypted version of the private key and a platform-specific decryption key, wherein the decrypted private key grants access to the wallet.

9. A processing system, comprising:
at least one memory having executable instructions stored thereon; and
one or more processors configured to execute the executable instructions to cause the processing system to:
receive a request to access a wallet on a blockchain, the request including an authorization code associated with the wallet and user credentials associated with an owner of the wallet;
decrypt a first portion of a private key based on the authorization code and a salt associated with the user credentials;
decrypt a second portion of the private key based on credentials associated with an application through which the wallet is accessed; and
grant access to the wallet based on the decrypted first portion and the decrypted second portion of the private key.

10. The processing system of claim 9, wherein the authorization code associated with the wallet comprises an alphanumeric string.

11. The processing system of claim 9, wherein the authorization code associated with the wallet comprises one or more question-answer pairs.

12. The processing system of claim 9, wherein to decrypt the second portion of the private key, the one or more processors are configured to cause the processing system to decrypt a first sub-portion of the second portion based a first set of credentials associated with the application and a second sub-portion of the second portion based on a second set of credentials associated with the application.

13. The processing system of claim 9, wherein the salt comprises a randomly generated number encrypted using a key associated with the user credentials.

14. The processing system of claim 9, wherein the one or more processors are further configured to cause the processing system to:
receive a request to generate the wallet, the request including at least the authorization code associated with the wallet;
select the private key associated with the wallet from an entropy pool of private keys; and
generate the wallet based on the selected private key.

15. The processing system of claim 9, wherein to grant access to the wallet, the one or more processors are configured to cause the processing system to grant access to withdraw items stored in the wallet to an external resource based on signing a transaction using the decrypted first portion and the decrypted second portion of the private key.

16. The processing system of claim 9, wherein to grant access to the wallet, the one or more processors are configured to cause the processing system to:
generate an intermediate encrypted version of the private key based on the decrypted first portion and the decrypted second portion of the private key; and
decrypt the private key based on the intermediate encrypted version of the private key and a platform-specific decryption key, wherein the decrypted private key grants access to the wallet.

17. A computer-readable medium having executable instructions stored thereon which, when executed by one or more processors, performs an operation comprising:
receiving a request to access a wallet on a blockchain, the request including an authorization code associated with the wallet and user credentials associated with an owner of the wallet;
decrypting a first portion of a private key based on the authorization code and a salt associated with the user credentials;
decrypting a second portion of the private key based on credentials associated with an application through which the wallet is accessed; and
granting access to the wallet based on the decrypted first portion and the decrypted second portion of the private key.

18. The computer-readable medium of claim 17, wherein the authorization code associated with the wallet comprises an alphanumeric string.

19. The computer-readable medium of claim 17, wherein the authorization code associated with the wallet comprises one or more question-answer pairs.

20. The computer-readable medium of claim 17, wherein decrypting the second portion of the private key comprises decrypting a first sub-portion of the second portion based a first set of credentials associated with the application and a second sub-portion of the second portion based on a second set of credentials associated with the application.

21. The computer-readable medium of claim 17, wherein the salt comprises a randomly generated number encrypted using a key associated with the user credentials.

22. The computer-readable medium of claim 17, wherein the operations further comprise:
receiving a request to generate the wallet, the request including at least the authorization code associated with the wallet;
selecting the private key associated with the wallet from an entropy pool of private keys; and
generating the wallet based on the selected private key.

23. The computer-readable medium of claim 17, wherein granting access to the wallet comprises granting access to withdraw items stored in the wallet to an external resource based on signing a transaction using the decrypted first portion and the decrypted second portion of the private key.

24. The computer-readable medium of claim 17, wherein granting access to the wallet comprises:
generating an intermediate encrypted version of the private key based on the decrypted first portion and the decrypted second portion of the private key; and
decrypting the private key based on the intermediate encrypted version of the private key and a platform-specific decryption key, wherein the decrypted private key grants access to the wallet.
